(19) United States
(12) Patent Application Publication
(10) Pub. No.: US 2002/0035574 A1
(43) Pub. Date: Mar. 21, 2002

(54) APPARATUS AND METHOD FOR EXPORTING DATA FROM A DATABASE TO A DATA PROCESSING TERMINAL

(76) Inventor: Mr. Jean-Baptiste Dumas, Paris (FR)

Correspondence Address: Arnold, Dompieri, Lerner, David, Littenberg, Krumholz & Mentlik, LLP, 600 South Ave. West, Westfield, NJ, 07090, US, 908-654-5000, 908-654-7866

(21) Appl. No.: 09/817,550

(22) Filed: Mar. 26, 2001

(30) Foreign Application Priority Data
Sep. 4, 2000 (FR) 0011243

(51) Int. Cl. G06F 17/30

(52) U.S. Cl. 707/200; 707/4; 707/10

(57) ABSTRACT

### Abstract of Disclosure

A data management device is provided which comprises a loading module (7) for accessing data from a reference database and a selection module (8) for allowing a user to make a selection from among this data as a function of the categories of reference data to which the data belong. These categories correspond to the categories of data of an information management module (9) of a main data processing terminal (1). The main data processing terminal also comprises a screen (12) and an exporting module (10) for exporting the selected data to the information management module (9). As a result, the selected data are stored with the data of the corresponding categories of the information management module.

### Background of Invention

The invention relates to data management and more particularly to exporting of data contained in a database to a data processing terminal.

By data processing terminal, it is meant any type of data processing equipment which allows the exchange of computer data and the display of data on a screen, and in particular Personal Digital Assistants (PDA).

The recent development of public telecommunications networks (such as the Internet, for example) as well as private networks (such as Intranet type networks, for example) has made it possible to create, and has made publicly available, numerous databases detailing events such as conferences, exhibitions, seminars, fairs and the like. Similarly, information content such as an electronic newspaper or targeted information can be recovered by a mobile data processing terminal. These databases or information sources are generally contained in data processing sites known as websites when they are connected to the Internet. Access to one of these databases is obtained by connecting a data processing terminal to the site which contains it via the communication network.

Once a database has been accessed, it is possible, using certain software modules, to download its contents onto a terminal and then to navigate within these contents after disconnecting. However, it is not possible to establish a "dialogue" between the database contents and specific applications such as those provided by "electronic" data managers which are provided in numerous terminals.

For example, the contents of a database relating to events can be downloaded onto a terminal, but the information relating to the dates on which the events will be held, and less still the data associated with these events, cannot automatically be transferred to an application of this terminal of the "electronic diary" type. The same is true, for example, of electronic newspapers remotely loaded onto a PDA. The only solution currently available, apart from manual operation, is to carry out a "cut and paste" operation using dedicated software. Consequently, the management of the information collected is limited.

This drawback is all the more irksome when the terminal is a personal digital assistant (PDA) acting primarily as an electronic diary, electronic index and possibly navigator making it possible to consult raw data which have previously been exported. Certainly, interfaces have been proposed which make it possible to export general information directly into the calendar or list of the PDA. But this relates only to information of the type providing warnings of aircraft delays or demonstrations, or reminding the user of operations which have to be carried out, such as courses, or lists of meetings to be exchanged between colleagues, and not contents giving details of an event.

### Summary of Invention

The aim of the invention is to overcome the disadvantages described above.

For this purpose, it is proposed to provide a data management device for a data processing terminal, known as the main terminal, equipped with a screen for displaying data and an information management module enabling the user to choose a category of information data from a number of categories with a view to displaying the data in this category on the screen. This device is characterised in that it comprises: (1) a loading software module which enables a user to access data contained in at least one reference database located in a data site which is accessible via a network (public or private) via cable or otherwise and wherein the data is associated with categories of reference data which correspond to the categories of data of the information management module; (2) a selection software module supplied with data by the loading module and enabling a user to select at least some of this data depending on the classes of reference data to which it belongs; and (3) an export software module which exports the selected data to the information management module of the main terminal so that it is stored with data of the categories which correspond to the respective reference categories.

By "main terminal," it is meant here any type of data processing terminal equipped with data exchanging means and a display screen. It may be, for example, a fixed or portable computer or a fixed or portable telephone or a personal digital assistant (PDA) or a games console or a watch. Moreover, the term "reference database" here denotes a database in which the data is classified according to the above-mentioned criteria of belonging to categories, as opposed to a "primary database" in which the data is raw, i.e. non-classified or not associated with categories.

Thus, once the reference database has been created, the loading module can access its classified data (or data collected according to the categories to which the data belongs: for example time data intended for diary use, descriptive data intended for thematic use, address data intended for an index, spatial location data intended for a plan display application), and some of this classified data can be selected and then transferred into a selected application of an information manager with a view to integrating it with the data of this application.

Numerous variants may be envisaged. In a first embodiment, the reference database is stored in a data processing site known as the primary site connected to a network and accessible via another data processing site of the "gateway" type. In this case, the loading module is arranged to allow access to the reference database via the gateway site.

In a second embodiment, the reference database is formed from a primary database stored in a primary data processing site connected to a network. This reference database is then stored in a gateway site which is connected to the network. In this case, the loading module provides direct access to the data of the reference database. To allow the reference database to be formed, the device comprises a data extraction module capable of extracting from the primary database at least some of its data, and a classifying software module for classifying the data extracted from the primary database into the reference database depending on whether the data belongs to the reference categories. It is therefore particularly advantageous for the extraction and classifying modules to be housed in the gateway site.

In a third embodiment, the primary database is provided on an information storage medium such as an optical, magnetic, magneto-optical disk or the like and the reference database is formed from the data contained in the medium.

Moreover, the main terminal may be connectable to the network or connectable to an auxiliary terminal (connected to the network). In the first case, it is particularly advantageous if the main terminal contains the selecting and exporting modules and optionally the loading module. In the second case, it is advantageous if the auxiliary terminal contains the selecting and exporting modules and optionally the loading module, and an information manager in which the selected data is exported. It is also advantageous for synchronisation to occur between the main terminal and the auxiliary terminal to allow the export (or transfer) of the selected data from one information manager to the other.

Moreover, the device according to the invention may comprise a connecting software module for associating complementary data with the data selected before the selected data is exported to an information manager. The connecting software module preferably accesses this complementary data in the application which manages the data with which the complementary data is associated.

In order to facilitate the selection of the classified data by a user, the selection module may be controlled by voice command means contained in the selecting terminal, i.e. either the main terminal or the auxiliary terminal.

In a preferred embodiment which is adapted to the management of data relating to events such as a conference, the selecting module gives users the opportunity to select data from the classes "agenda", "subjects", "speakers", "exhibitors", "sponsors", "registered persons" and "plans". Preferably, the reference data is grouped into at least two categories in accordance with a chosen criterion so that the data of a first category can be accessed freely but the data of a second category can only be accessed under certain selected conditions.

According to a further feature of the invention, the device preferably comprises a registration module enabling a user to obtain an account number and/or an identifier and then to register for an event associated with at least some of the reference data. This module may also allow a user to register himself on a list for the receipt of selected information or an electronic publication so as to select all or some of the information available. Preferably, a user can only access data of the second category once he has registered. In this case, it is advantageous for the device to have a transaction module enabling a user to pay, by a secure electronic route, for all or some of a service associated with an event, or for information content to which he has signed up, including registration for the event.

The invention also relates to a data management process for a main data processing terminal of the type described hereinbefore. This process is characterised in that it comprises at least the steps indicated hereinafter.

In a first step (a), data of at least one reference database, in which the data is associated with categories of reference data corresponding to the categories of data of the information management module, is accessed. This reference database may be stored in a primary data processing site connected to a public or private network, by cable or otherwise, and accessible via a gateway site. In the alternative, the reference database is stored in a gateway site and formed from data stored in a primary site connected to the network. In the latter case, in a preliminary step, data is extracted from the primary database, then the extracted data is classified in the reference database depending on the reference categories to which the data belongs.

In a second step (b), at least some of the data which has been accessed in step (a) is selected depending on the categories of reference data to which the data belongs. Moreover, in this step, it may be possible to associate complementary data with the data selected.

In a third step (c), the selected data is exported to the information management module of the main terminal so that, preferably, the data is stored with the data of the categories which correspond to the respective reference categories of the information management module. When selection is carried out via an auxiliary terminal equipped with an information manager, this step may comprise a preliminary phase in which the data selected is exported into the information manager of the auxiliary terminal before being transferred (exported) into the information manager of the main terminal, for example during synchronisation between the terminals.

The device and process according to the invention may be used for numerous applications other than conferences, for example for selecting information relating to an exhibition, a fair, a museum visit, a show, a seminar, a meeting of employees and/or shareholders of at least one company. The device and process are also particularly well suited to the selection of media information data of the spoken or written press (newspapers, magazines and periodicals) and for reserving services and/or tickets, namely in the field of transport, shows, exhibitions, hotels, restaurants and travel. The device and process are also suited to the reservation of services associated with an exhibition stand and to the management of meetings associated with private information.

Further features and advantages of the invention will become apparent from a study of the detailed description which follows, and the accompanying drawings.

### Brief Description of Drawings

FIG. 1 shows in highly diagrammatic form a communication apparatus incorporating a personal digital assistant equipped with a management device according to the invention;

FIG. 2 is a block diagram which illustrates in highly diagrammatic form a device according to the invention installed in a personal digital assistant;

FIG. 3 is a diagram illustrating an example of a screen page for selecting categories of data, after sorting;

FIG. 4 is a diagram showing an example of a screen page for presenting the main data of the "diary" category;

FIG. 5 is a diagram showing an example of a screen page for presenting and selecting different data associated with one of the main data of the "diary" category in FIG. 4;

FIG. 6 is a diagram showing an example of a screen page for presenting and selecting the main data of the category "subjects";

FIG. 7 is a diagram illustrating an example of a screen page for presenting and selecting the main data of the category "speakers";

FIG. 8 is an algorithm illustrating an example of the process according to the invention; and

FIG. 9 is a diagram showing all the zones which can be displayed on each screen page to enable the transfer of data associated with an element selected from the corresponding page, or to create links with other categories of information.

### Detailed Description

The accompanying drawings are essentially accurate by nature. Consequently, they may serve not only to complete the invention but also contribute to the definition thereof, if necessary.

The invention relates to a data management device for a data processing terminal. As indicated in the introduction, this device relates to any type of terminal which is equipped on the one hand with a screen for displaying data and on the other hand with a personal information manager (PIM) generally made in the form of a software module coupled with electronic components such as a memory.

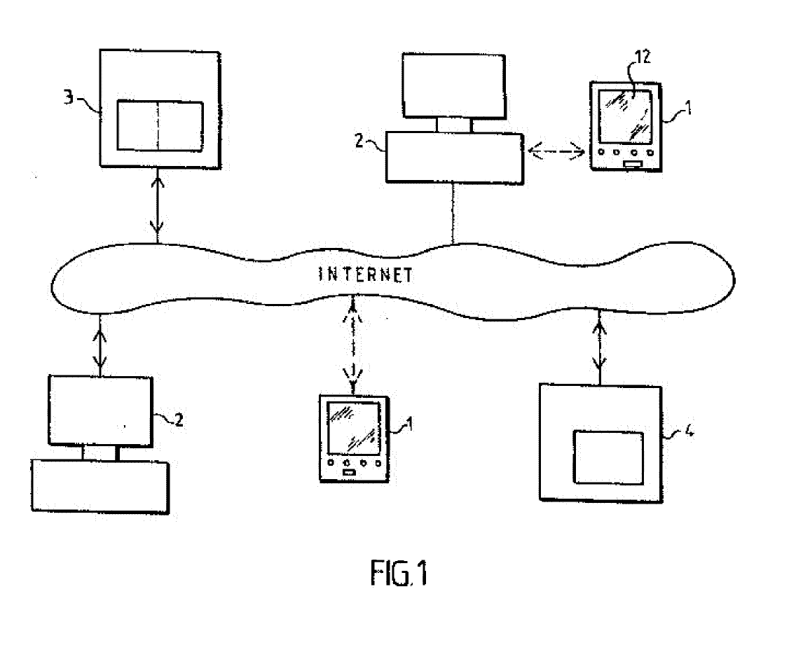

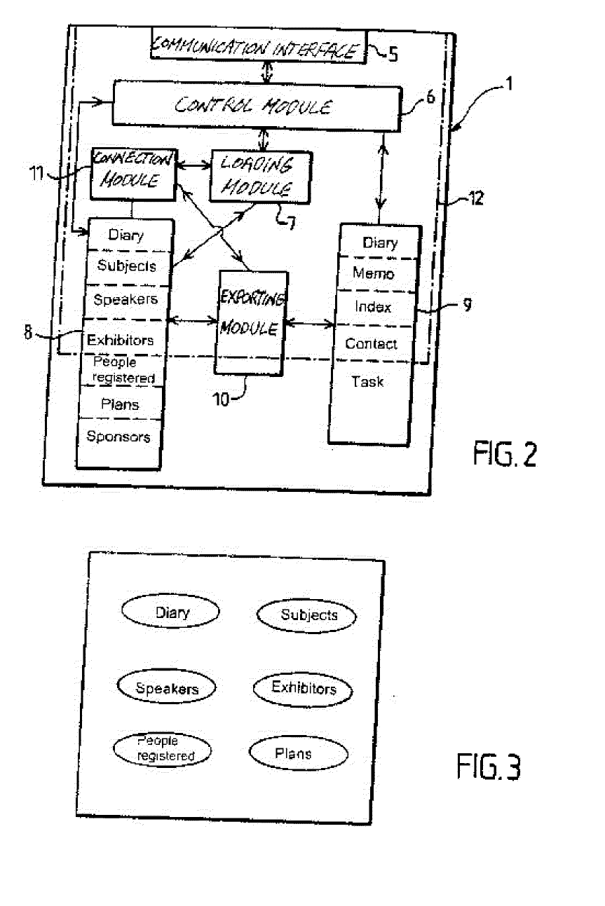

In the examples shown in FIGS. 1 and 2, the management device according to the invention is intended to manage data for a personal digital assistant (PDA) 1 which is capable of holding a dialogue (exchanging data) with another terminal such as a computer or microcomputer 2 connected to the Internet public network. Of course, the PDA 1 may be arranged to be connected directly to the Internet public network without passing through an auxiliary terminal 2. Moreover, the auxiliary terminal 2 or the main terminal PDA 1 could be connected to a private network of the Intranet type rather than to a public network. The auxiliary terminal may also be an infrared terminal connected to a public or private network or capable of receiving data from another auxiliary terminal of the microcomputer type.

Also connected to this public Internet network are information sites 3, 4 (or websites) some of which comprise a database such as an events database. Websites 3, 4 of this kind may be created to inform the public of an event such as a conference, an exhibition, a fair, a seminar or the like. However, the site may also relate to a museum.

To access a site comprising a database and accessible via the Internet, a request has to be issued comprising the address "URL" (standing for Uniform Resource Locator). These addresses are preferably sent to an application server dedicated to administering events.

The event sites 3, 4 relating to a conference or exhibition generally contain a very large amount of information from which a selection has to be made to make optimum use of one's time. In fact, it is common at a conference or exhibition for several events to take place at more or less the same time spreading over several days. Moreover, some events may relate to partially identical subjects. On the other hand, some exhibitors, speakers (or contributors) and participants (people who have registered) may only be present at certain times. The management of the information data contained in the databases of this type of site 3, 4 may therefore prove particularly useful.

Generally, in this type of event site, some of the information is directly accessible by anyone whereas the rest of the information is accessible only by people who have registered for the event and have an access code.

Currently, the user of a PDA 1 can download (export) the information content of a database directly into his PDA. For this to be accomplished, his PDA 1 has to be fitted with suitable software such as, for example "Mobi Pocket" "Peanuts Reader" or "Avant Go", the latter converting the contents of any website into the PDA format. Using this software, the user can also navigate in the information content which has been downloaded but he cannot institute a dialogue between the information content and the other (main) applications of the PDA. In particular, this software does not allow him to export information into the other applications, which means that in order to export in this way he has to use conventional functions of the "cut and paste" type using a text manager, which is a time consuming and tricky operation. By "other applications," it is meant here those which are offered by the personal information manager (PIM) provided in the PDA 1 and most data processing terminals (see in particular the Microsoft Outlook software made by Microsoft). PIMs of this kind offer applications of the type "diary", "memo", "task manager", "index" and "contacts".

The aim of the invention is to overcome the disadvantage described above.

For this purpose, it is proposed to provide a data management device which, according to the alternative embodiments, may either be installed integrally in a main terminal such as a PDA 1, installed integrally in an auxiliary terminal 2 such as a microcomputer, or integrated partly in a main terminal such as a PDA 1 and partly in an auxiliary terminal such as a microcomputer 2.

A device of this kind is preferably made in the form of software modules. However, it could also be partly produced using electronic components such as specialised circuits. For example, a module could be provided made up of electronic circuits controlled by software modules stored in its memory, and intended to be introduced (inserted) in a location suitable for this purpose in a PDA, or connected thereto. However, a storage module could also be provided in which software modules are stored which are capable of being transferred into the PDA. Modules of this kind are marketed by the companies HANDSPRING and SONY.

In the example shown in FIG. 2, all the modules of the device which enable a user to select data (loading, selecting and exporting) are installed in a PDA 1 in the form of software modules which will now be described.

A PDA 1 comprises, like any other data processing terminal, a communication interface 5 which allows the terminal to be connected directly to a public or private network, or to an auxiliary terminal 2. This communication interface 5 is connected to the control module 6 of the PDA 1 (made up in particular of microprocessors coupled to ROM and RAM type memories). The PDA also comprises a data display screen 12 managed by the control module 6 and a personal information manager (PIM) 9, coupled to the control module 6 and providing applications of the type "diary", "memo", "index", "task manager" and "contacts", in particular.

The data management device comprises a loading module 7 coupled to the control module 6 enabling the user of the PDA 1 to access the data of a reference database (and not the primary database, to which we will return later) installed in a website 3, 4, either of the type known as "primary" because it has been created specifically for the event and generally by the event organiser, or of the type known as "gateway" because it is accessible on a web page at the same time as other sites or other applications. This access may be either free or by payment. Alternatively, the reference database is stored in a primary site and its classified data is accessible to the user of the PDA only through the gateway site.

As will be seen hereinafter, the invention can only operate provided that the user is able to select data which has previously been classified in predefined categories. Consequently, by "reference database," it is meant a database in which the data is classified or associated with categories. A primary site may contain a reference database of this kind, for example as a result of an agreement with the owner of the gateway site. However, the primary site may contain only a primary database in which the information is raw, i.e. unclassified or not associated with categories. Of course, as indicated previously, the primary database may be transmitted on an information storage medium (or data storage processing equipment).

Generally, the primary databases of the event type comprise both public data and non-public data. Consequently, the reference database is built up from at least some of the non-public data and preferably at least some of the public data of the primary database. This reference database is then stored either in the gateway site or in an auxiliary site.

The establishment of a reference database from a primary database requires on the one hand an extraction software module capable of searching for all or some of its data in the primary database and, on the other hand, a classifying software module capable of classifying, in the reference database, the data extracted, depending on the reference categories of this reference database to which the data belongs. Of course, the reference database is built up before it is made accessible to PDA users.

Depending on the particular configuration chosen, the loading module 7 enables a user to consult the information either in a primary website 3, 4 or in a gateway site or again in an auxiliary terminal 2 into which all or some of the reference database has previously been downloaded.

The device also comprises a selection module 8 preferably coupled to the loading module 7 and also to the control module 6. This selection module 8 is designed to allow the user of the PDA 1 to select information (or data) from among the categories of reference data. As shown, a category of time data, of the diary type, a category of thematic data, a first category of index data of the "speakers" type, a second category of index data of the "people registered" type, a third category of index data of the "sponsors" type, a fourth category of index data of the "exhibitors" type and a category of location data of the "plans" type may be provided, enabling a person to locate a room or an exhibitor or a poster or a restaurant.

Of course, other categories of data may be envisaged.

All these reference categories have a link with the data which is managed by the different applications of the personal information manager 9 of the PDA 1.

There are two possible cases. Either all the categories in the reference database are returned, by means of the loading module 7, to a memory managed by the selection module 8 (thus producing a copy of the reference database equivalent to the original), then the selection is made from the copy, and the selection module 8 stores the selected data in reference categories. On the other hand, the selection module 8 may allow the user to make his selection directly from the reference database and consequently the selection module 8 merely stores, in the reference categories, the data selected from the reference database by the user. The selection is preferably carried out using object-oriented technology in which each category describes a set of data and associated processing. In other words, when the application handles objects, the processing which may be carried out on the data (defined by its categories) is perfectly determined.

The data selected by the user by means of the selection module 8 is handled by an exporting module 10 coupled to the selecting module 8 and the personal information manager 9.

The exporting module 10 performs the functions of selective automated exporting of the data selected to the categories of data corresponding thereto in the various applications of the personal information manager 9 (diary, memo, index, contacts and task manager). This exporting is carried out only on the orders of the user, as will be seen hereinafter. If a copy of the reference database is stored in the memory managed by the selection module, this is preferably deleted from the memory after the exporting operation.

Thus, once the selected data has been integrated in the applications of the PIM 9 of the user's PDA 1, he can consult it at any time without having to save the downloaded contents of the reference database or go back and consult this database in the website 3, 4. Moreover, when the user is present at an event, he does not have to carry around bulky documents in which information cannot always be found rapidly.

The device may also contain a connection module 11 coupled to the selection module 8 and preferably to the loading module 7, and intended to enable the user to associate information data with the data selected via the selection module 8.

Reference will now be made to FIGS. 3 to 7 to describe the operations of selecting and exporting data.

As mentioned previously, once the loading module 7 has enabled the selection module 8 to access all or some of the data of a reference database, the user is asked to make his selection from this data. A page, of the type illustrated in FIG. 3, is displayed on the screen of the terminal and is used to make the selection. In this case, it is the screen 12 of the PDA 1 (see FIG. 1).

This page shows the different selection categories. These are the categories "diary" (or "Date Book"), "subjects", "speakers", "exhibitors", "people registered", and "plans". The number of categories as well as the type of categories are not limited to the illustrated examples. For example, a category "sponsors"can be added or used in place of one of the above cited categories.

It should also be noted that in other embodiments of the invention, the denomination of the categories can be changed. For instance, in the case of information delivered to Companies, the categories can be "The word of the President", "General Information", "Seminars", "Conference", "Information relative to employee notification". In the case of the electronic newspaper application, categories may be for instance "Headline News", "Finance", "Politics", "Hightech", "Medical Healthcare", "Events relating to culture".

In the case of PDA 1, the screen 12 is a touch screen. Consequently, to access one of the selection categories, pressure has merely to be applied to the zone of the screen 12 associated with this category using the stylus of the PDA 1. Of course, if the selection were made on a microcomputer without a touch screen, this could be done using a mouse. Moreover, whether it be on a PDA or a microcomputer, the selection means could conceivably be controlled by a voice command module. Combinations of control keys (or zones), pointers and vocal command may also be envisaged. More generally, the vocal command module may be arranged to carry out any type of processing in the PDA and not just the selection of contents.

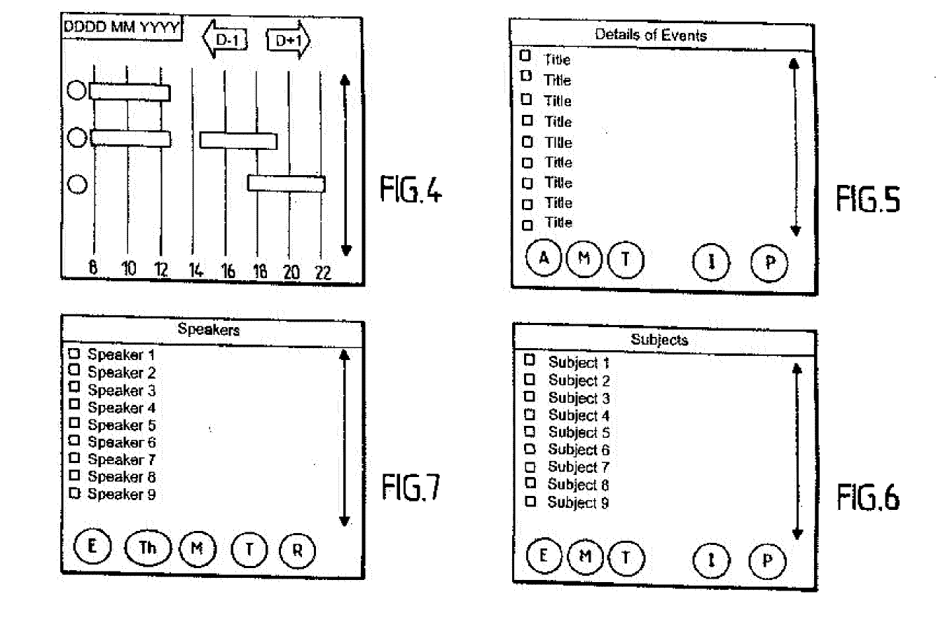

Thus, when the category "diary" is selected, a screen page is obtained of the type shown in FIG. 4. A number of pages may be provided for one event, e.g. for a conference which is taking place over several days. To go from one page to another, i.e. to move about among the different days of an event, the user has only to click on the arrows placed in the upper part, the arrow "D-1" enabling the user to go back to the previous day and the arrow "D+1" enabling him to go to the next day, the display page acting as a reference day, of course.

Each segment of the particular event is placed in a rectangle, for example. A segment may be, for example, a plenary session, a poster session or any other event section defined by the organiser of the event. The rectangle can be subdivided, for instance when a session does not last half a day.

Preferably, the selection module 8 is capable, after the selection of data is carried out by the user in another selection category, of associating "underlying" information with the data which characterises the event defined in one of the rectangles. To access this underlying information, the user has only to press his stylus against the rectangle in question. The underlying information then appears in what is known as a pop-up window. It may be, for example, a short description of the event mentioning the title of a session, the name of the participants, the subject or title of the talks and a location.

A scroll bar is also provided (in this case on the right-hand side of the page) to enable the user to follow the events of the day when they will not all fit on the same screen page.

Finally, the numbers displayed in the bottom part of the screen page denote the hours of the day.

In order to allow the user to select one or more events, an activation zone (in this case circular) is also provided opposite each event line, on the right side or, as illustrated, on the left side.

When the user applies his stylus to one of these zones, the selection module 8 displays a new page on which are shown all the elements which make up the corresponding event. A page of this kind is illustrated in FIG. 5. The event is broken down into elements such as a spoken presentation. Preferably and as illustrated, each element may be defined by at least a title. But the element may also be defined by a start time, a finish time, the name or names of the speakers and the location of the room. Again, preferably, the selection module is designed, following a selection of data carried out by the user in another selection category, to associate each element with underlying information such as, for example, a summary of the presentation which is to take place. To obtain this summary, the user simply has to press his stylus on the element which interests him and the summary will then be displayed in a pop-up window.

A pop-up window may also be provided for displaying the underlying information associated with the event referenced in the top frame. These may be for example general comments on this event.

At the end (or as illustrated in front of) each definition of an element is provided a zone (in this case a square) for selecting it. The user makes his selection by ticking the box with his stylus, for example. Moreover, as with the previous page illustrated in FIG. 4, a scroll bar is preferably provided (in this case on the right-hand side of the page) to enable the user to run through all the elements which make up the event displayed.

Finally, a plurality of zones are provided (in this case at the bottom of the page) for transferring (or exporting) the data associated with the element selected on this page to applications of the personal information manager 9 of the PDA 1, or making it possible to create links with other categories of information (to create the underlying information mentioned earlier). This may be, for example, contact details of the participants (letter I) or a location mentioned on the plan of the event (letter P). The denomination of the zones or the letter chosen as shortcuts to command the actions is given as example, and may be modified.

Preferably, when the user applies his stylus to zones containing references to the categories of information designated by the letters I (for guests) and P (for plan), the user accesses only the data which is linked to the elements of the event selected. For example, by activating the zone containing the letter I, the user can access the details of the people participating in the elements which he has just selected. Similarly, when the user selects the letter P, he will display on his screen the plan of the event and the places where the selected elements are to take place.

The zone containing the letter A enables the user to export, into the "diary" section of the personal information manager 9 of his PDA, the data associated with the elements which he has selected on the page "event". More precisely, all the data associated with the selected element will be exported into the "diary" section at the corresponding day and hour to be stored with the previous time data.

Preferably, the connecting module 11 is designed so as to enable the user to export, in the form of a note, any information associated with the element of the event selected. A note of this kind might, for example, be exported into the application known as "detail/note" which is contained on Palm-type PDAs. This note could contain, for example, data as to the location and/or the summaries of the events. As an option it might also be possible to export the details of the participants associated with the elements of the selected event into the "index" application of the PIM 9 of the PDA 1. This can be done by using the "I" key of the participants application.

The zone containing an M enables the user to export into the application "memo" of the PIM 9 the data associated with the elements selected on the page and/or the underlying data associated with these selected elements. The same is true of the zone comprising the key T which enables the data associated with the elements of the selected event to be exported to the "task manager" application of the PDA.

The export zones are managed by the export module 10.

Naturally, other zones may be provided for other types of export to other applications of the information manager of the PDA. It is also possible to provide a zone which enables the selection page to be switched to the personal information manager 9 of the PDA.

FIG. 6 shows an example of a page displayed on the screen 12 of the PDA 1 when the user selects the category "subjects" with his stylus.

For this category of data, and unlike the "diary" category of data, the user directly accesses the page on which the various subjects characterising the event can be selected. Of course, a different procedure could be used.

At the top, this page comprises a rectangle in which the category of data is given and which, when a stylus is applied, preferably allows a pop-up window to be displayed containing general comments as to the event as a whole and the choice of subjects, for example. The subjects of the event are displayed one after the other, each one being preceded or followed by a zone (in this case a square) enabling it to be selected. As with the selection of the elements of the event, a subject is preferably selected by ticking a box using the stylus of the PDA.

Again, preferably, the selection module 8 is designed to associate the underlying data with the data which defines the subject on the page displayed. To access this underlying data, the user has only to apply his stylus to the subject which interests him for a pop-up window to appear. This menu may also contain a description of the subject and a summary of the development of this subject, for example.

Again, and in this case on the right-hand side, a scroll bar is provided so that the user can run through all the subjects when they will not all fit on a single page.

Finally, and as with the selection page for the event elements, zones intended for the exporting of selected data are provided at the bottom of the page.

The zone containing the letter E allows the data to be exported to the elements of the events which are linked to the subjects selected. This zone consequently serves to interface the subjects selected with the events. For example, the arrows "D-1" and/or "D+1" will be "highlighted" on the "diary" page on which the various events are mentioned if the subject or subjects selected are spread over several days.

The zone containing the letter M makes it possible to export the selected data, as indicated earlier, to the "memo" application of the PIM 9 of the PDA 1. The same is true of the zone containing the letter T which can be used to export the selected data to the "task manager" application of the PIM 9 of the PDA 1.

The zones containing the letters I and P perform the same functions as those described hereinbefore with reference to FIG. 5.

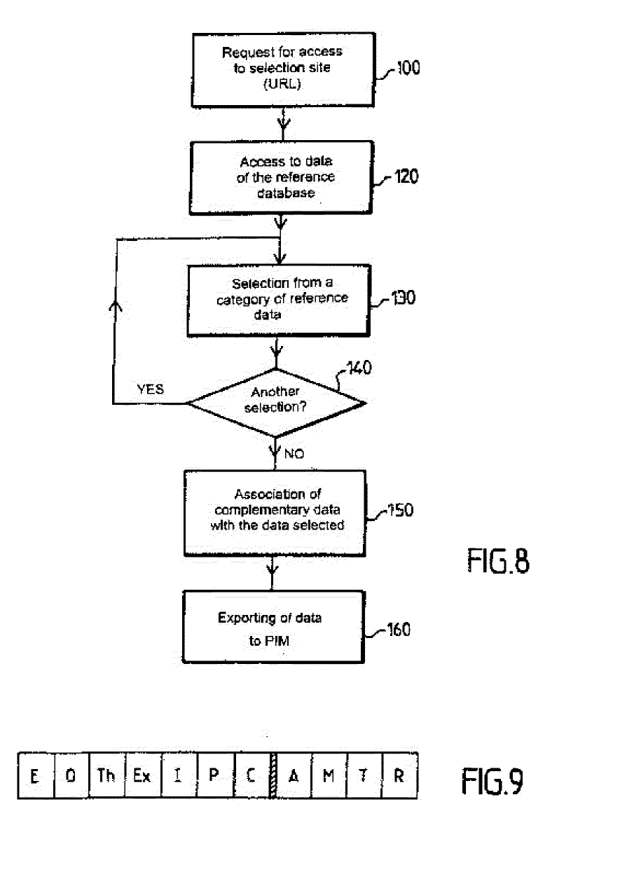

FIG. 7 shows the "speakers" page which is displayed on the screen 12 of the PDA 1 when the user selects the "speakers" data category by applying his stylus to the page illustrated in FIG. 3.

This page "speakers" gives the names of the speakers (or participants) at the event. Each speaker name is preceded by a zone (in this case a square) which enables it to be selected. The speaker is preferably selected by ticking the selected box using the stylus of the PDA 1. Preferably, the selection module is designed so as to associate underlying data with the data displayed. This may be, for example, the professional credentials of the speaker (or participant). This underlying data may be displayed in a pop-up window when the stylus is pressed onto the name of the selected speaker.

The lower part of the screen contains the zones for exporting the selected data.

The zone containing the letter E allows the data selected to be exported to the events linked to the selected speakers. For example, by applying the stylus to the letter E, the user can move onto the "diary" page shown on FIG. 4, and the events linked to the selected speakers are highlighted.

The zone containing the letters Th makes it possible to interface the selected speakers with the "subjects" page. Thus, by applying the stylus to the Th zone the user moves onto the "subjects" page shown in FIG. 6, and the subjects associated with the selected speakers are highlighted.

The zone containing the key M can be used, as described previously, to export the selected data on the "speakers" page to the "memo" application of the PIM 9 of the PDA 1. The same is true of the zone containing the letter T which enables the selected data from the "speakers" page to be exported to the "task manager" application of the PIM of the PDA. Finally, the zone containing the letter R allows the details of the speakers (or participants) selected to be exported to the "index" application of the PIM of the PDA.

Clearly, for the "subjects" and "speakers" pages, other exporting zones may be envisaged as well as a zone for switching directly to the PIM of the PDA.

For the other categories of data and particularly the categories "exhibitors", "sponsors"and "persons registered", pages similar to the "speakers" page may be used. For the "exhibitors" page an additional export zone is provided containing the letter P for locating the stands where the selected exhibitors can be found. Moreover, in a pop-up type window, the activities of the exhibiting company whose name has been touched by the stylus can be displayed as well as the contact details of the company and persons to contact for example. Of course, the exhibitors participating in subjects and events can be exported either to the subjects and events pages or from the subjects and events pages into the address book, for example.

The "persons registered" page enables the user to access the alphabetical list of people who are to participate in the event. As with the other pages, a pop-up type window can provide at least some of the details of a registered participant, preferably with his agreement, and his details can be exported to the "index" application of the PIM of the PDA. The "sponsors" page enables the user to access the alphabetical list of people who are to sponsor the event. As with the other pages, a pop-up type window can provide at least some of the details of a sponsor, preferably with his agreement, and his details can be exported to the "index" application of the PIM of the PDA.

The page which is displayed on screen 12 of the PDA when the user selects the data category "plans" on the screen page shown in FIG. 3 makes it possible to display the method of access and the location of events (day after day), the subjects (day after day), the exhibitors (industrial or conference posters), and the particular locations such as for example the dining rooms, mobile or fixed refreshment stands, toilets, telecommunication means, infrared terminals (for downloading data into the PDA), public computers, broadcasting aerials, etc.

FIGS. 5 to 7 show a number of examples of juxtapositions of export zones. These are merely provided as an illustration without being restrictive. In fact, as shown in FIG. 9, one might envisage the same juxtaposition of export and navigation zones being placed on all the screen pages. More precisely, in the embodiment shown in FIG. 9, the zones E (event), O (speakers, participants), Th (subjects), Ex (exhibitors), I (persons registered), P (plans) and C (search) denote the functions of navigation in the event management application, whilst the zones A (diary or Date Book), M (memo), T (tasks or "To Do List") and R (index or "address") denote the export functions into the PIM of the PDA.

In an alternative variant, the zones may be called up by pressing the stylus onto part of the screen or the writing surface of the PDA. Another embodiment consists in using scrolling menus which appear when the menu button of the PDA is pressed.

The device according to the invention may also comprise a search module coupled with the loading module 7, to enable the user to search for certain information in the data downloaded, or directly in the database. Thus, any type of search function may be envisaged such as, in particular, sections truncated to the left and right, expression searches, boolean searches, searches with a time limit or category limit or location limit.

In another embodiment, the action obtained by pressing the zone can be realized by a combination of movements of the stylus on the writing zone of the PDA. For example,"/A" can be used to export data to the Agenda. The type of combination will depend on the chosen application.

The device according to the invention can also update the information exported, on the assumption that the data of the database would evolve. This updating may either be automated, for example by regularly interrogating the database, or it may be suggested to the user in the form of warnings telling him of all the amendments made to the database.

The foregoing description describes an embodiment of the invention in which the management device is integrally installed in the main terminal (in this case the personal digital assistant PDA). However, the device according to the invention could be integrally installed in an auxiliary terminal such as a fixed or portable microcomputer or a portable telephone operating by the WAP protocol, for example (Wireless Application Protocol) (or any other data communication protocol intended for mobile terminals), or more generally to any type of data processing equipment provided with a screen and capable of being connected to a public or private network, by cable or otherwise, by whatever type of communication protocol.

Assuming that the data management device according to the invention is integrally installed in an auxiliary terminal 2, all the access and selection operations are preferably carried out in the auxiliary terminal. In other words, the loading and selecting modules 7 and 8, respectively, are preferably installed in the auxiliary terminal 2. The exporting of data into the applications of the personal information manager 9 of the main terminal (for example a PDA) is preferably carried out automatically each time the main terminal 1 and auxiliary terminal 2 are synchronised; it is therefore preferable for the exporting module 10 to be placed in the auxiliary terminal 2.

There are two possible cases. In a first case, the auxiliary terminal 2 has a personal information manager of a type equivalent or identical to the one installed in the main terminal 1. In this case, the data selected using the selection module 8 is exported (or transferred) into the PIM of the auxiliary terminal 2 by means of the export module 10 while waiting to be exported during the next update to the PIM of the main terminal 1. In the second case, the data selected is "frozen", for example in a buffer memory, and is transferred (or exported) during the next update to the PIM 9 of the main terminal 1.

In another alternative embodiment, the device according to the invention may be partially installed in an auxiliary terminal 2 and in a main terminal 1. For example, the loading module may be installed in the auxiliary terminal 2 while the selection module 8, connecting module 11 and exporting module 10 are installed in the main terminal 1. In this case, the auxiliary terminal acts only as a buffer memory for loading the contents of the database or as a connection interface with the Internet for accessing a database of a website.

Preferably, all the information relating to an event is centralised in a relational database such as the "Oracle 8" database, for example. Alternatively, the information relating to the event is stored in a first database while the information relating to the visitors who have registered is stored in a second database.

Whichever version is envisaged, it is particularly advantageous to group the reference data in at least two categories as a function of a selected criterion. Thus it is possible to make certain data of a first category, typically data of presentation of an event, freely accessible on the welcome site while other data (of a second category), typically the details of the participants, the persons registered and the publicity and the like can only be obtained under certain specified conditions, for example when the user has actually registered for an event.

For this purpose, the device according to the invention preferably comprises a registration module enabling a user (or more generally an agent) to obtain an account number and/or a personal identifier, with the aim of being able to register for one event among those which are presented on the site. This may also enable a user to sign up for a list of selected information or one or more publications in electronic form which are accessible via the site, so as to select all or some of the information available. Only when the user has registered will he be able to access the private data in the second category.

Moreover, it is advantageous if the device comprises a transaction module enabling a user to pay, preferably by a secure electronic route, for all or part of a service associated with an event for which he has signed up, including the registration fee for this event.

These transaction and registration modules of the device according to the invention may be made in the form of software modules. However, they may also be made, at least in part, in the form of electronic circuits. They are installed partly in the main user terminal and partly in a site server.

All the software modules of a device according to the invention, which have to be installed in the main terminal of a user, are preferably remotely loadable from the site server, e.g. once the user has been given an account number and/or an identifier. In an alternative embodiment, the software modules may be installed by transferring files contained on a storage medium supplied to each user who has been given an account number and/or an identifier during a previous connection to the site or when registering by post or by telephone.

The device according to the invention can be used in the field of transmitting information such as, for example, the contents of newspapers or periodicals or magazines, and more generally information media accessible on a public network (such as the Internet) or a private network. A certain number of these information sources may in effect be downloaded via an application such as AvantGo, MobyPocket, PalmTop or Alladino. However, no application allows the information content (in electronic form) to be exported to an information management module such as that of a PDA, in particular. The invention solves this major inconvenience.

In fact, by means of the invention, the user can download all the information content of a newspaper, for example. The data in this content is classified according to headings (such as politics, economics, finance, culture, food, the weather, sport, etc.) which will correspond to the same number of options on the entry page of the application. After having selected a heading, the user will be able to see the titles of the corresponding articles, then by "clicking on" (or more generally selecting) an article he can read the contents of the article. Then the user can export all or part of the contents of the article to the "task manager" or "memo" application or to the "diary" application to associate it with a date (for example with a view to re-reading it at a later stage), but he may also export parts of the article to other applications such as, for example, the "address book" application for storing addresses of companies, restaurants, shops, exhibitions, optionally combined with critical commentaries.

The device according to the invention has another application in the field of reserving services and tickets, and particularly seats at shows. For this purpose, a company having a list of shows (or the like) can make this list available to users on their main terminal, notably their personal assistant (PDA). The user can thus select one or more shows and export the corresponding dates and times to his "diary" application noting the details of the show (such as the address where it is to take place, the telephone number, the name of the show, a description of it (summary, names of the performers or actors and the like)). Preferably only the data associated with the show for which a reservation has been confirmed are retained in the user's main terminal.

The invention also relates to a process for managing data for putting into effect the device described hereinbefore. This process therefore relates to a main data processing terminal as defined hereinbefore and comprising at least the steps described below, with reference to FIG. 8.

In a step 100, a user requests access to a site (in this case the gateway site) connected to the Internet by giving the site's URL address, for example. In a step 120, the data of at least part of the reference database contained in the site are accessed. As indicated above, an alternative embodiment is possible in which the reference database is installed in a primary site, for example by the organiser of an event. In this case, the gateway site acts as an intermediate point between the interrogation terminal and the primary site.

These steps 100 and 120 constitute a first step (a).

When the reference data of the database is collected in at least two categories in accordance with a selected criterion (public or private data), then,in step 100 a phase of assigning an account number and/or an identifier to each user making the request is carried out, so that the user can register for an event (or a selected list of information or one or more publications in electronic form) and can access the private data in the second category (only the public data in the first category being freely accessible; this might be, for example, the general data relating to the presentation of an event).

When the reference database is in the gateway site, this indicates that it has been formed beforehand from the data of a primary database stored in a primary site connected to the network (Internet, for example). In this case, the process comprises a preliminary step in which at least some of the information contained in the primary database is extracted from the gateway site, then the data extracted is categorised in the reference database depending on the reference categories to which the data belongs.

In a step 130, at least some of the data from the reference database is selected according to the categories of reference data to which the data belongs. The categories correspond to the categories of the user's information management module. Selection may be carried out either directly in the site where the reference database is located or in the main terminal after downloading of the database, or in an auxiliary terminal to which the main terminal is capable of being connected.

At the end of a selection from a category of data, a test is carried out in step 140 to determine whether another selection has to be made. If so, the process returns to step 130. If not, it moves on to step 150.

In this step 150, complementary data, e.g. in the form of a note, may be associated with the data selected. In an alternative embodiment, step 150 may be carried out before step 140.

Steps 130 to 150 constitute step (b).

Finally, in a step 160 (or step (c)), the data which have just been selected and optionally annexed are exported to the standard applications of the information management module of the main terminal (for example a PDA) so that the data are preferably stored with the data of the categories corresponding to the respective reference categories.

When selection is carried out using an auxiliary terminal fitted with an information manager, and not directly in the main terminal, a preliminary phase is provided in which the data selected is exported into the information manager of the auxiliary terminal, while awaiting transfer (export) into the PIM of the main terminal, for example during synchronisation between the two terminals.

In the foregoing description, a gateway site has been described in which the reference database is installed or which acts as an intermediate for access to a reference database of this kind when the reference database is installed in a primary site. A gateway site of this kind may serve to indicate a certain number of cultural, sport, scientific, technical, financial or political events taking place in the world or in part of the world, such as for example in the country or region where the user connected to this gateway site is located. This gateway site may for example suggest a number of applications, particularly those offered by the invention, namely the selection of information contents.

The information which is accessible on or via this gateway site is preferably collected over the worldwide web using powerful search engines of the type proposed by the companies ARISEM or AUTONOMY and combined under headings which will be described hereinafter. However, this information may equally be supplied by clients of the owner of the gateway site and notably those who have primary databases or reference databases as described hereinbefore.

It is also possible to provide users with practical information of a general nature, such as for example information as to ways of reaching a town or a museum, etc., as well as links to other sites which might potentially be of interest to the user.

Preferably, an advertising strip is displayed on the welcome screen of the gateway to alert the visitor to the fact that particular attention has been given to the filtering of the information available. Consequently, the user is immediately informed that all the events or happenings catalogued in the gateway site have been filtered so as not to have any paedophilic, pornographic or racist content, etc. At the end of the strip, a zone may be provided for telling the owner of the site (or webmaster) of any site or sites and/or events of an immoral nature which can be accessed via his gateway site and of which he might not be aware. Moreover, strips, banners and the like for displaying publicity information and/or sponsors may also be displayed on the screens of the gateway site.

As a non-restrictive example, the information collected (and contained) in the gateway site may be organised in a matrix of dimension 7, each dimension corresponding to one of the headings given above.

The first heading which might be called "what", for example, denotes the type of events. It might be in particular a cultural, sporting, scientific and technical, financial and economic, or political event.

The second heading which might be "when", for example, gives the dates of the events or happenings.

The third heading which might be "where", for example, specifies the locations of the events sorted according to continent/country/town, for example.

The fourth heading which might be "who-1", for example, names the participants at an event and the titles or summaries of the presentations by these participants.

The fifth heading which might be "who-2", for example, lists the organisations who have organised and/or sponsored the events or happenings.

The sixth heading which is called, for example, "key words" gives the archiving of the information as a function of general key words.

Finally, the seventh heading which might be, for example, "events on the site" lists all the events for which the information content can be delivered to the main terminals and consequently gives access to these events.

Once they have arrived at a gateway site of this kind, the users (or visitors) can search for information by following the hypertext links, for example by replying to windows positioned on the screen page opposite predefined questions, or using a selection mask for accessing the headings described above.

For example, the welcome page of the gateway site may also comprise, in addition to the welcome message and the publicity zone and partnership zone, a zone indicating the application of selection of contents to which the invention relates, a zone showing the exhibition news, a search zone by category or keywords or the like and a zone for personalising a series of information. Of course, the number and content of the zones is in no way fixed.

The user who "clicks" on the zone relating to the selection application (or function) arrives at a welcome page which may contain a rolling banner intended to give exclusive news as to the coverage of an event such as the Olympic games or a world championship or an international conference.

On this welcome page and preferably in the welcome zone the name of the owner of the gateway site is mentioned (e.g. a company), so that simply by clicking on this name the user can obtain information on the owner, the object of the site, the method of visiting the site (its various headings and modes of interrogation), the filters of the site, people to contact in order to obtain other information on the site (for example e-mail addresses) and a presentation of the selection application.

The exhibition news zone brings the user to a page where the important exhibitions of the moment are shown in categories. Such information may be classified by continent and/or country and/or region depending on the location of the visitor or his request.

The search zone brings the user to a page which can be subdivided into several parts, notably an effective search zone, a "site/starting" zone and an "explorer" zone.

The "site/starting" zone may serve as an entry point to the event information site. The visitor or user can then choose between running through pages as a function of hypertext links which will guide him in his search and using several interrogation modes to find the information which interests him.

The "explorer" zone gives access to a certain number of categories such as, for example:-the "type of event": this category may be broken down into information sub-categories such as cultural, sporting, scientific and technical, financial and economic, and political information, each sub-category itself being capable of being broken down into other sub-categories as a function of the nature of the information available.

-the "date of the event";-the "place of the event": this category may be sub-divided into continent, country, town;-the "participants in the event": this category specifies the name of the organisers and the participants, if available. It may also mention the title of the conference and the summary;-the "organisation (organiser/sponsor) of the event";-the "key words": this category contains the most significant words of the titles of the events and descriptions of the events, the names of the organisers, the organising bodies and/or sponsors, etc.;-the "site events": this category gives direct access to all the events for which the information contents are available via the applicatory selection function to which the invention relates.

Preferably, at any time, the visitor finding themselves inside a category can call up a menu of the type "refine the search" which enables him, starting from his entry point in a category, to refine his search by cross-referencing the data with that in the other categories.

The heading "search" gives access to search pages using different methods. Some of them may only relate to simple questions (searching by category) or more elaborate questions based on the cross-referencing of categories.

As an example, questions of the following kind may be asked:-"At what conference will the company XX be presenting their products or their strategy, etc.?"-"Which conference will Mr. Y be attending in the coming three months?"-"Which conferences has Mr. Z attended recently?"-"I know that the company ZZ, the conference organiser, is due to organise a conference in Europe in the near future regarding new information technologies. Could you tell me the date and place of this conference?"-"In order to bring me rapidly up to date on the question ZZ, could you tell me all the conferences in the field of AA in the X months to come?"Although this is a type of explorer or search mode, the user or visitor can preferably always record his interrogation profile and ask to receive regular updates.

The zone designated "my personal page" is a heading intended to create a specialised information report for the visitor/user. Preferably, the screen page associated with this heading is divided into two large sections. In the first section the visitor can choose certain types of general information, e.g. from among political, financial, economic, stock exchange, weather, astrological information, etc. In the second section the visitor can create one or more information selecting masks.

The visitor/user may also ask to be informed as soon as a new object appears in one of his masks, while defining an alerting time frame.

It is clear that the site giving access to the reference databases is preferably a gateway site but it could be a simple site dedicated exclusively to the selection of contents. In another alternative embodiment, the reference database may be installed in an auxiliary site to which access is gained via the gateway site, e.g. by means of a hypertext link. In this variant, the generation of the reference database may be sub-contracted to the owner of the auxiliary site, and in this case it is preferable for the extraction and classifying modules to be installed in the auxiliary site.

Moreover, the foregoing description dealt with one reference database to which access is gained by a main or auxiliary terminal. However, it is clear that within the scope of the invention it is possible to gain parallel access to a plurality of reference databases each dedicated to an event or happening.

The process according to the invention may also comprise a step enabling an agent (and in particular a user) to reserve a service or a ticket, as will be seen hereinafter. For this purpose the process also preferably comprises a step enabling a user who has registered for an event to carry out a secure electronic transaction relating to this event, e.g. in order to pay for all or part of their registration or a service connected with this event.

An embodiment of a setup which integrates main user terminals (notably PDAs or portable telephones) will now be described, which involves not only the event organisers and users of main terminals but also all the other agents connected (or capable of being connected) with an event such as the exhibitors, participants, partners and promoters.

As mentioned hereinbefore, the events are presented on a site connected to a public network such as the Internet and/or a private network.

This site is implanted in a master server (for example of the type IIS5.0) comprising different interfaces for the exchange of data with the terminals of the different categories of agents (organisers, exhibitors and participants, partners and promoters, users), preferably in a secure environment, by Http or Https electronic mail (for example in flat files with separators of the ";" type or in the XML or XLS format). The interfaces are preferably software modules produced as ASP (Active Server Page) so as to allow updating in real time. An application server (for example of the XTND Connect Server type) coupled to the master server may also be provided for ensuring the synchronisation of data when the multiple connections are made. The master server may be of the type IIS5.0 but may alternatively consist of two servers (primary and auxiliary) mounted in series, for example of the PowerEdge 2450 type.

The site is also connected to a database preferably installed in a database server fitted with a database management system (DBMS, for example of the type SQLServer7.0) to which it communicates all or some of the data received, optionally after processing. This communication between the site and the database may take place either automatically by means of feed scripts placed on the server side when the files conform to a standard or manually when the files do not conform to a standard.

More preferably, two databases stored in the same server are provided to increase reliability and cope with high numbers of visits. For example, the first database may contain all the site management data while the second database may contain all the agent data accessible on the site.

Each agent may thus be connected to the site to make an online request for the purpose of obtaining an identifier and an account number. Preferably, the identifier and the account number are supplied after confirmation of the request by the agent.

Once registered the agent can make other requests intended for the transmission of specific data, e.g. in order to communicate information relating to an event in the case of an operator or to register for an event, e.g. in the case of a user, or to reserve a location, for example in the case of an exhibitor or a promoter or partner.

A promoter or partner can thus buy advertising space and/or frequencies of broadcasting for advertising strips by filling in an online order form in which he selects broadcasting slots from those available and optionally broadcasting themes. He then sends the image file of his advertising strip. The request for broadcasting is then stored in the database and the strip is placed on the site online in accordance with the parameters selected.

This may also enable agents, once they have registered for an event, to communicate amendments or additional information. In addition it may allow an organiser to manage, in particular, information relating to people who have registered for the event which is being organised, or to obtain analyses such as statistics. This information, contained in the database, is communicated to the organiser via a master server having an interface and connected to the Internet (for example).

This also enables a registered user to download the software modules of the device which are required for the application into his main terminal fitted with an information management module (fixed or portable computer, fixed or portable telephone, notably those of the GPRS and UMTS types, personal digital assistant (of whatever the model or the operating system) such as for example the PALM, PSION, HEWLETT-PACKARD ("JORDANA"), COMPAQ ("i-PAQ H3630"), SONY ("CLIE"), CASIO ("Cassiopea"), AGENDA COMPUTING ("Agenda VR3"), games console, watch with a data display screen and the like). It is only after downloading and registering for an event that the user can consult on line the information relating to the event, then select this information and download it onto his main terminal. He can also modify his personal parameters on the site and/or access related information of the publicity or promotion type on the site and on his main terminal.

Moreover, once the exhibitor has registered, he has access to a preferably secure transactional space, which enables him to make a reservation and/or booking on line. To do this he has to fill in a reservation or booking request form specifying the conditions requested for the selected event. Preferably, he can also pay a registration fee for an event and a deposit or the full amount of a reservation or booking online in secure manner. Alternatively, the payment may be made by cheque then validated by electronic mail. The status of the reservation or booking can also be consulted online.

Online reservation by exhibitors, participants, partners and promoters may relate to any type of service, notably the reservation of hostesses, telephone lines, hotels, restaurants, travel documents and the like.

Advantageously, the users of main terminals can also make an online reservation of hotels, restaurants, travel documents and the like.

Generally speaking, the site invoices the organisers of the events for certain services carried out online in their place, such as for example registrations to events or the management of user data for a given event (payment of registration fees, visiting statistics, number of downloads associated with registrations for a given event, volume of data exchanged). Preferably, the online registration fees for an event are not billed to the user.

Preferably, the information which is available to users on the site is classified according to levels of confidentiality. For example, two categories may be provided: a first category N1 which includes public general information distributed free of charge such as, for example, information describing the events (agendas, subjects tackled, access plan) and a second category N2 containing private information (on payment) which requires registration prior to an event, such as for example the contact details of the speakers, exhibitors and participants who are officially registered.

The information accessible on the site is regularly updated. Consequently, the software modules of the applications downloaded by the users onto their main terminals are preferably arranged so as to update the information modified since the last download.

The invention also applies to the next generation of PDA adapted for UMTS or GPRS. These PDA could be always, or most of the time, connected to Internet. So, a user connected to a web site through his PDA will be able to access to the levels of information above described (for example a free level, and a private level reserved to registered users). It will be possible for a user to access data such as Date, Localization of an event, Address of a speaker, and so on. Consequently, a user browsing on a web site with his PDA could save at least some of the data displayed on the screen. For this purpose, it is possible to use the exportation module, or an additional dedicated module, for creating an html link containing the internet address of the web page, in the diary, the address book, the task list or the memo list of the Personal Information Manager (PIM) of the PDA. So, every time the user wants to access the web page, he only has to click on the stored html link. In another embodiment, the exportation module (or the dedicated module) directly exports data selected by the user in the PIM of his PDA, as above described.

The invention is not restricted to the embodiments of the device and process described above purely by way of example but covers all the variants which may be envisaged by the skilled person within the scope of the claims which follow.

Thus, applications to events, particularly those relating to large organised events have been described, but it also relates to events proposed on an Internet gateway or within a business or group of businesses, possibly in conjunction with software such as OUTLOOK or LOTUS. The invention may also be applicable to the field of diary management, particularly for accountancy experts, for example to integrate fiscal dates and/or important accounts or personnel profiles of information which is to be exported, or for doctors, for example for managing meetings via a secretary and/or client data and/or target professional data, or again for individual people, for example when managing reservations or subscriptions to concert cycles or theatre plays (the concept of exporting dates and reservation times coupled with information about the shows to which the reservations relate might be envisaged). This invention may also be applied to the automated collection of information relating in particular to events such as seminars, fairs and conferences. In fact, a mobile terminal user may ask to be informed of the events in a particular field, such as for example genetics, or physics, or the security of Internet transactions. Once the user has made his selection he is informed of any event corresponding to his choice, by direct transfer of at least some of the data to his terminal.

The invention also relates to the exporting of information contents, for example of newspapers which are accessible on an Internet type network, while the user may export all or part of a text into his PIM in a "note", "memo" or "diary" application, in particular, with the possibility of choosing an export date and/or specific information defined by key words such as, for example, addresses of hotels, restaurants, businesses or specified places.

The invention additionally applies to the tourist industry, notably tourist guides or visits to places such as museums or castles, as well as certain large hotels which have a number of dining rooms and/or conference rooms and/or cinemas and/or sports and commercial complexes, for example.

Claims

(AMENDED) A data management device for a main data processing terminal, said main data processing terminal comprising a screen and an information management module, said information management module being adapted to enable a user of said main data processing terminal to select information associated with a plurality of information categories for displaying the selected information on the screen, said data management device comprising:
a loading module designed to access data in at least one reference database in which said data is associated with reference categories, said reference categories corresponding to said information categories;
a selection module designed to receive said data from said loading module and to enable said user to select at least some of said data, said selected data being associated with at least one of said reference categories; and
an exporting module designed to export the selected data to the information management module for storage with information associated with at least one information category, said at least one information category corresponding to said at least one reference category.

(AMENDED) A device according to claim 1, wherein said reference database is contained in a data site connected to a network and said loading module is designed to access the data stored in said data site.

(AMENDED) A device according to claim 2, wherein said data site is a gateway site and said gateway site comprises an extraction module designed to extract from a primary database stored in a primary data site connected to the network at least some of said data, and further comprising a classifying module adapted to classify said data with respect to said reference categories.

(AMENDED) A device according to claim 3, wherein the classifying module is stored in the gateway site.

(AMENDED) A device according to claim 2, wherein the data site is a primary site which is accessible via a gateway site connected to the network and said loading module is designed to access the data stored in said primary site via said gateway site.

(AMENDED) A device according to claim 2, wherein said main terminal is adapted to connect to said network.

(AMENDED) A device according to claim 2, wherein said main terminal is adapted to connect to an auxiliary terminal, said auxiliary terminal being connected to the network, and said loading module is designed to download to said auxiliary terminal from the network at least some of said data, and said exporting module is designed to export to said main terminal the selected data from said auxiliary terminal.

(AMENDED) A device according to claim 1, wherein said exporting module and said selection module are installed in said main terminal.

(AMENDED) A device according to claim 7, wherein said auxiliary terminal comprises a screen and a second information management module, said second information management module being adapted to enable a user of the auxiliary terminal to select said information associated with said plurality of information categories for displaying the selected information on the screen of the auxiliary terminal, the selection module being installed in said auxiliary terminal and adapted to enable a user of said auxiliary terminal to select the data by displaying the data on the screen of the auxiliary terminal, the exporting module being installed in said auxiliary terminal and designed to export the selected data to the second information management module for storage with information of said second information management module associated with said at least one information category.

(AMENDED) A device according to claim 1, further comprising a connecting module designed to associate complementary data with at least some of the selected data, before said export of said selected data, and wherein the exporting module is designed to simultaneously export the selected data and the associated complementary data.

(AMENDED) A device according to claim 1, wherein said reference categories comprise at least one category of time data, one category of descriptive data, one category of address data and one category of spatial location data.

(AMENDED) A device according to claim 1, wherein the main terminal is a device selected from the group consisting of a fixed computer, a portable computer, a fixed telephone, a portable telephone, a personal digital assistant, a games console and a watch.

(AMENDED) A device according to claim 1, further comprising voice command system installed in the main data processing terminal for controlling said selection module by voice commands.

(AMENDED) A device according to claim 1, wherein the reference categories comprise the categories of "diary", "subjects", "speakers", "exhibitors", "sponsors", "people registered" and "plans."

(AMENDED) A device according to claim 1, wherein said data is segregated within said reference database into a first category of data which is publicly accessible and a second category of data which is only privately accessible.

(AMENDED) A device according to claim 1, further comprising a registration module designed to enable said user to obtain one or both of an account number and an identifier for registering for an event associated with at least some of said data.

(AMENDED) A device according to claim 16, further comprising a transaction module designed to enable said user to pay, by a secure electronic method, for at least part of a service connected with said event.

(AMENDED) A data management process for a main data processing terminal, said main data processing terminal comprising a screen and an information management module, said information management module being adapted to enable a user of said main data processing terminal to select information associated with a plurality of information categories for displaying the selected information on the screen, said data management process comprising:
accessing data in at least one reference database in which said data is associated with reference categories, said reference categories corresponding to said information categories;
selecting at least some of said data, said selected data being associated with at least one of said reference categories; and
exporting the selected data to the information management module for storage with information associated with at least one information category, said at least one information category corresponding to said at least one reference category.

(AMENDED) A process according to claim 18, wherein the reference database is contained in a data site of the gateway type connected to a network, and further comprising extracting said data from a primary database stored in a primary data site connected to the network, and classifying said data from said primary database into said reference categories to form said reference database.

(AMENDED) A process according to claim 18, wherein the reference database is contained in a data site of the primary type connected to a network, and further comprising connecting to a data site of the gateway type for said accessing of said data, said data site of the gateway type being connected to the data site of the primary type via said network.

(AMENDED) A process according to claim 19, wherein the main terminal is adapted to be connected to said network, and further comprising downloading said data to said main terminal, via the network, for said accessing.

(AMENDED) A process according to claim 21, further comprising downloading said data to said main terminal via an auxiliary terminal.

(AMENDED) A process according to claim 18, wherein said main data processing terminal is associated with an auxiliary terminal, said auxiliary terminal comprising a screen and a second information management module, said second information management module being adapted to enable a user of said auxiliary terminal to select said information associated with said plurality of information categories for displaying the selected information on the screen of the auxiliary terminal, and further comprising performing said accessing and said selecting from said auxiliary terminal and, before said exporting, exporting said selected data to the second information management module for storage with information of said second information management module associated with said at least one information category.

(AMENDED) A process according to claim 18, further comprising associating complementary data with said selected data and simultaneously exporting said selected data and the associated complementary data.

(AMENDED) A process according to claim 18, wherein said reference categories comprise at least one category of time data, at least one category of descriptive data, at least one category of address data and at least one category of spatial location data.

(AMENDED) A process according to claim 18, wherein said data is segregated within said reference database into a first category of data which is publicly accessible and a second category of data which is only privately accessible.

(AMENDED) A process according claim 18, further comprising providing said user one or both of an account number and an identifier for accessing further data in said reference database and for registering for an event associated with said further data.

(AMENDED) A process according to claim 27, further comprising paying for said accessing said further data and said registering using a secure electronic method.

(AMENDED) A process according to claim 18, wherein said data relates to an event selected from the group consisting of an exhibition, a conference, a fair, a museum visit, a seminar, a show and a business meeting.

(AMENDED) A process according to claim 18, wherein said data relates to media information selected from the group consisting of newspapers, magazines and periodicals.

(AMENDED) A process according to claim 18, wherein said data relates to one or both of reserving services and obtaining tickets in areas selected from the group consisting of transport, shows, exhibitions, hotels, restaurants and travel.

(AMENDED) A process according to claim 18, wherein said data relates to reserving services associated with an exhibition stand.

(AMENDED) A process according to claim 18, wherein said data relates to managing meetings associated with private information.
